(19) United States
(12) Patent Application Publication
(10) Pub. No.: US 2012/0120220 A1
(43) Pub. Date: May 17, 2012

(54) WOUND MANAGEMENT MOBILE IMAGE CAPTURE DEVICE

(75) Inventor: Osama H. Al-Moosawi, Bear, DE (US)

(73) Assignee: WOUNDMATRIX, INC., Chadds Ford, PA (US)

(21) Appl. No.: 13/270,586

(22) Filed: Oct. 11, 2011

Related U.S. Application Data
(60) Provisional application No. 61/391,959, filed on Oct. 11, 2010.

(51) Int. Cl. H04N 7/18

(52) U.S. Cl. 348/77; 348/E07.085

(57) ABSTRACT

A mobile device and method for capturing and transmitting medical images. The mobile device includes a camera component configured to acquire an image, a communications interface configured to establish an operable connection to a server, and a processing device operably connected to the camera component and the communications interface. The processing device is configured perform the method of capturing and transmitting the medical images, the method including causing the camera component to acquire an image of a wound on a patient's body, receiving location information associated with the acquired image, wherein the location information indicates where on the patient's body the wound is located, and transmitting, in response to a user request, the acquired image and location information to the server via the communications interface.

### RELATED APPLICATION AND CLAIM OF PRIORITY

This application claims the priority benefit of U.S. Provisional Application No. 61/391,959 entitled “Wound Management Mobile Image Capture Device” and filed Oct. 11, 2010, the content of which is hereby incorporated by reference in its entirety.

### BACKGROUND

Recent advances in medical imaging technology have allowed medical professionals to collaborate on more projects than were previously possible. For example, a doctor in Europe can quickly forward an image to a doctor in the United States for review and evaluation. However, image capture, processing, and review devices for medical images are typically costly devices that require a major financial investment.

Portable devices have become more prominent in the medical field as well. A doctor may carry around a notebook computer, tablet computer, personal digital assistant (PDA) or other similar device to access and review medical images. However, the software programs run on these devices to access and review images are generally complicated and require training or repeated use to become proficient.

The cost and complexity of capturing, storing, transmitting and evaluating medical images have limited the use of medical image capturing to those working in the medical fields, specifically to those working in medical facilities where secure image capture devices are available. The cost and complexity have generally prevented the technology from expanding beyond typical use in medical facilities to use by patients at their homes, caregivers providing homecare to patients, and in-patient and out-patient treatment facilities and providers.

### SUMMARY OF THE INVENTION

This disclosure is not limited to the particular systems, devices and methods described, as these may vary. The terminology used in the description is for the purpose of describing the particular versions or embodiments only, and is not intended to limit the scope.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this document is to be construed as an admission that the embodiments described in this document are not entitled to antedate such disclosure by virtue of prior invention. As used in this document, the term “comprising” means “including, but not limited to.”

In one general respect, the embodiments disclose a method of acquiring and transmitting an image from a mobile device to a server. The method includes acquiring, via a camera component of the mobile device, an image of a wound on a patient's body; receiving, by a processing device operably connected to the camera component, location information associated with the acquired image, wherein the location information indicates where on the patient's body the wound is located; and transmitting, in response to a user request, the acquired image and location information to the server via a communications interface operably connected to the processing device.

In another general respect, the embodiments disclose a mobile device for capturing and transmitting medical images. The mobile device includes a camera component configured to acquire an image, a communications interface configured to establish an operable connection to a server, and a processing device operably connected to the camera component and the communications interface. The processing device is configured to cause the camera component to acquire an image of a wound on a patient's body, receive location information associated with the acquired image, wherein the location information indicates where on the patient's body the wound is located, and transmit, in response to a user request, the acquired image and location information to the server via the communications interface.

### BRIEF DESCRIPTION OF THE DRAWINGS

FIG. 1 illustrates an exemplary data transfer network for using an exemplary image capture device according to an embodiment.

FIG. 2 illustrates an exemplary process for enrolling a patient, acquiring and uploading a wound image from a mobile image capture device to a secure server according to an embodiment.

FIGS. 3a-3g illustrate exemplary screenshots of an exemplary mobile image capture device running a software application for performing the exemplary image capture process of FIG. 2.

FIG. 4 illustrates an exemplary process for registering a new patient and using an image capture device in a homecare environment according to an embodiment.

FIGS. 5a-5g illustrate exemplary screenshots of an exemplary mobile image capture device running a software application for performing the exemplary process of FIG. 4.

FIG. 6 illustrates an embodiment of a computing device for implementing the various methods and processes described herein.

### DETAILED DESCRIPTION

As used in this document, the terms “image” or “medical image” refer to an image of a wound, scar, burn, mole, growth, anomaly, or other similar malady of a bodily area of medical concern of a patient for review and evaluation by a medical professional.

“Mobile device” refers to any portable computing device capable of connecting to a communications network for the purposes of transmitting and receiving data. Examples of mobile devices include, but are not limited to, notebook computers, netbook computers, tablet computers, personal digital assistants (PDAs), cellular telephones, smartphones (i.e., a cellular telephone with an integrate mobile operating system incorporating additional features beyond those of a standard cellular telephone), and other similar devices.

An “image capture device” refers to a camera or photo sensor configured to transfer a captured image of an object to a computer readable memory device. As used herein, an image capture device will generally refer to a digital image capture device unless otherwise specified. Additionally, an image capture device will generally be integrated into a mobile and wireless digital device unless otherwise specified.

The present invention relates to a mobile device including software for capturing a medical image, defining a location of the medical image, and uploading the medical image from the mobile device to a secure server for plametric measurement, review and evaluation by a medical professional. The mobile device may be used by a patient or caregiver to capture and define the medical images so that repeated trips to a doctor's office are avoided for routine check-ups for a healing wound or other area of concern. The mobile device provides a portable means for documenting a patient's wound care.

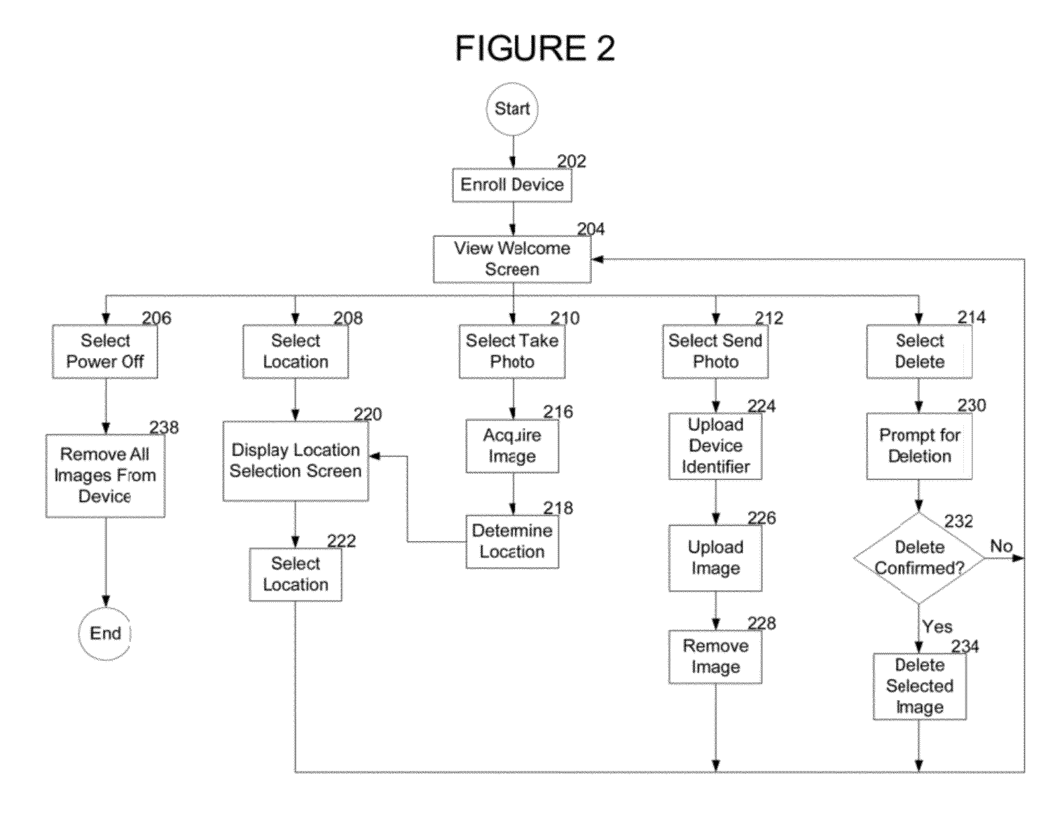

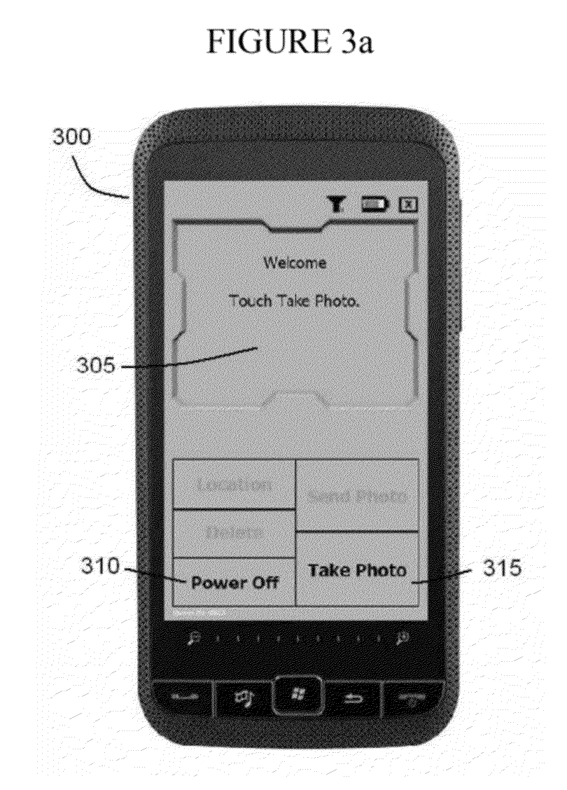

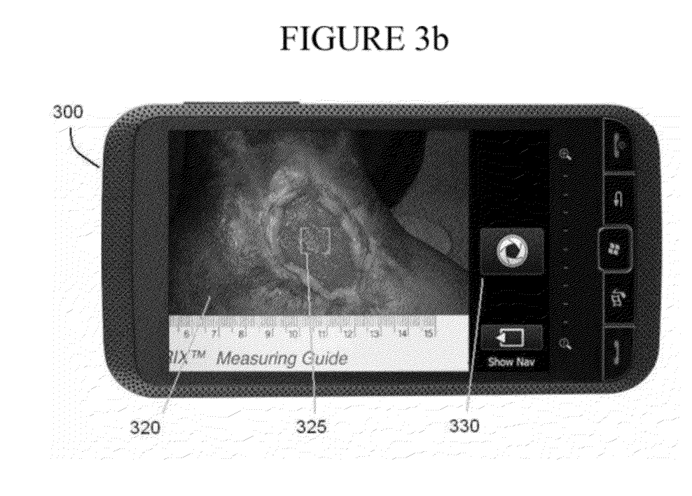

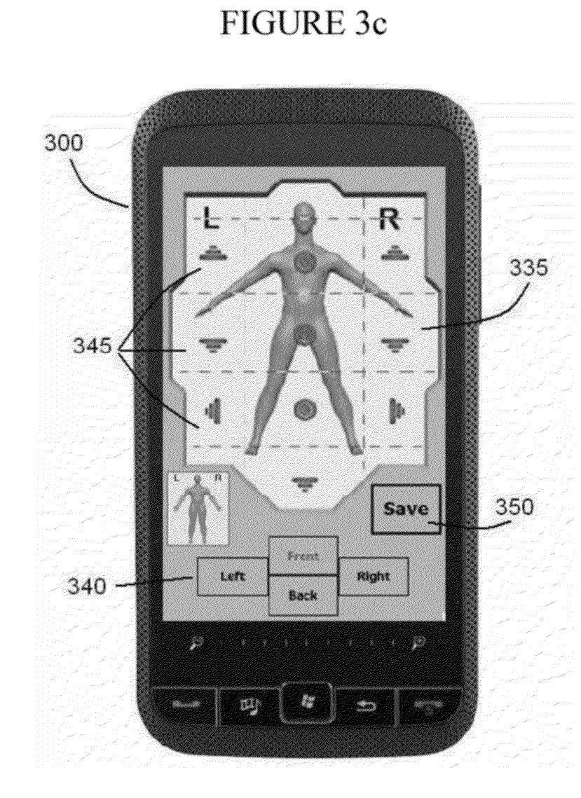

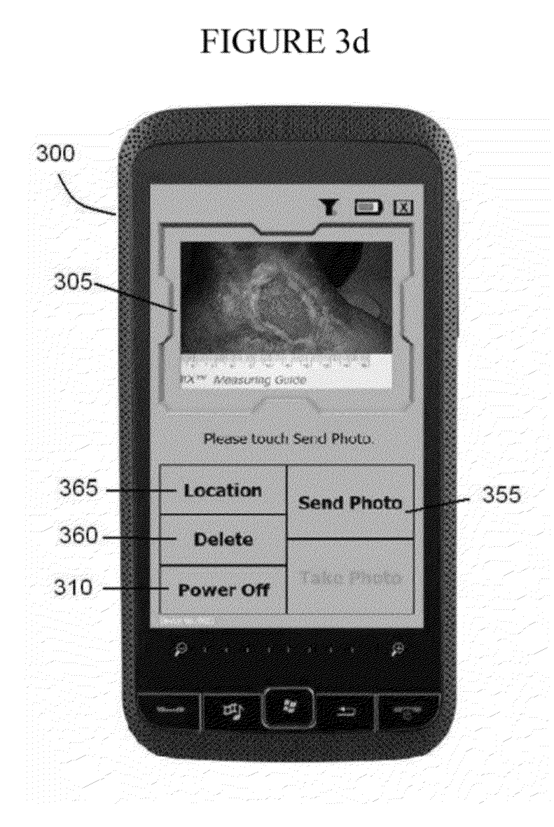

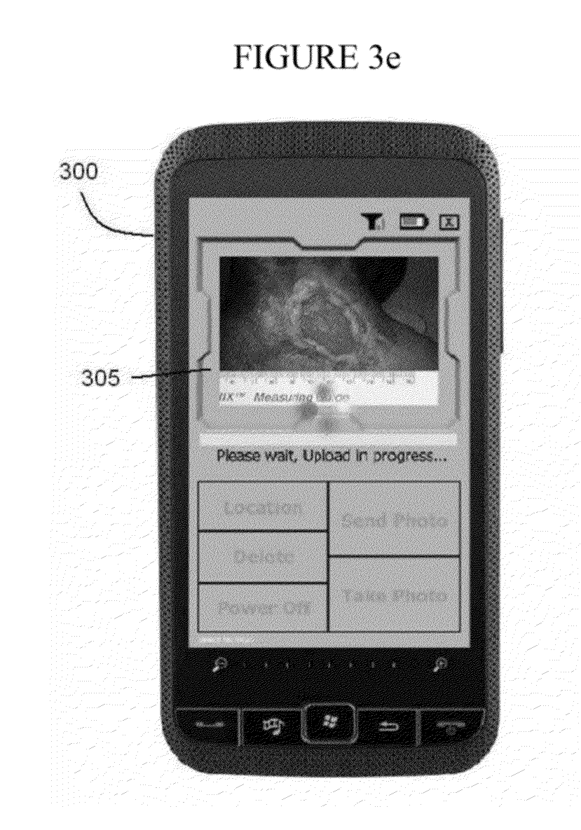

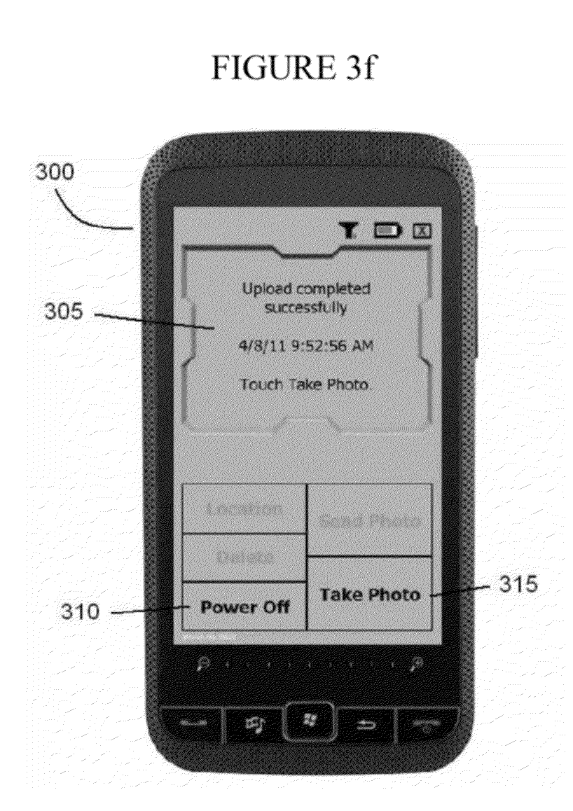

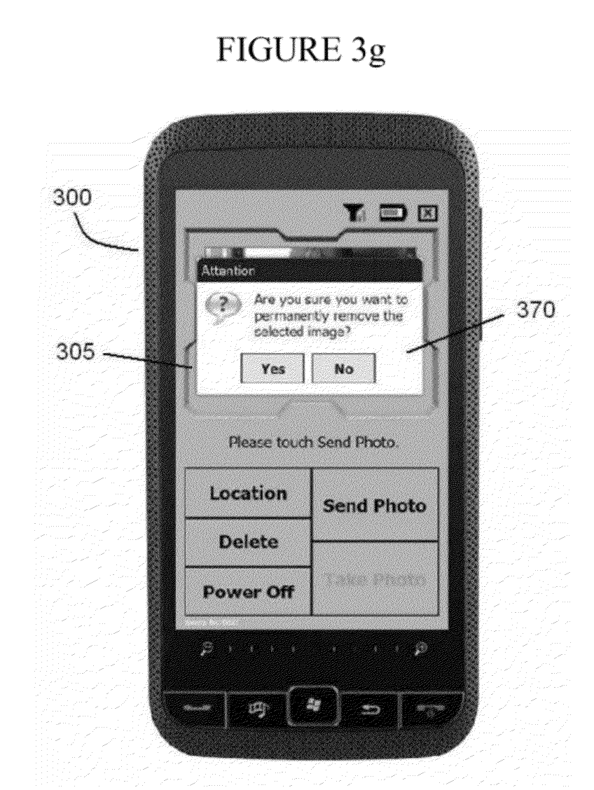

The medical mobile device, such as a smartphone, may be owned by the patient. A medical professional, caregiver or medical provider may install appropriate software such as a downloadable application onto the patient's mobile device and review the software with the patient, including the steps followed to capture, define and upload a medical image. Then, the patient may capture medical images in their own home, forwarding the images to their doctor or other medical professional, and receive information related to the area of concern without the added inconvenience of going to the doctor's office, thereby saving time and expense. An exemplary process and application interface for such a device is discussed below with respect to FIGS. 2 and 3a-3g.

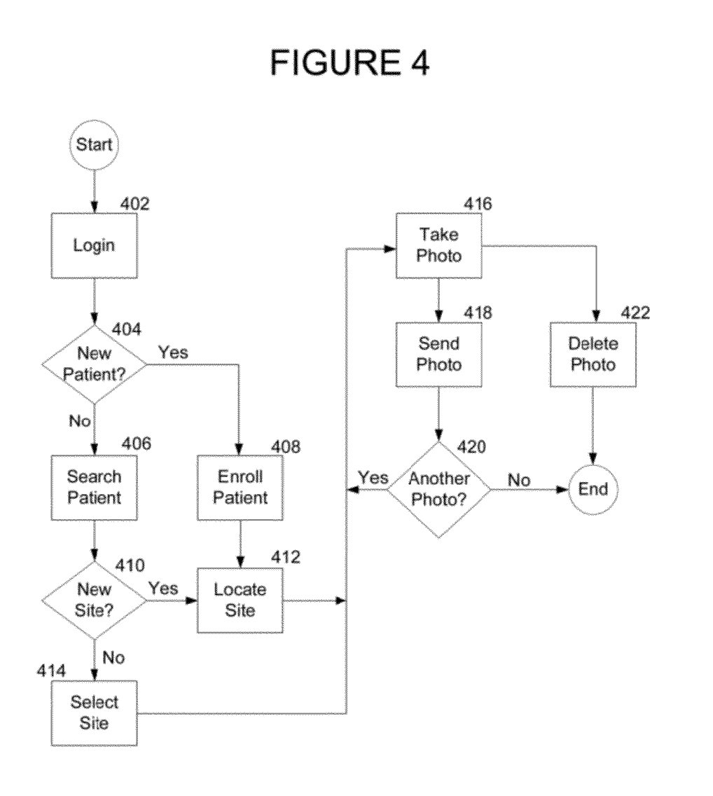

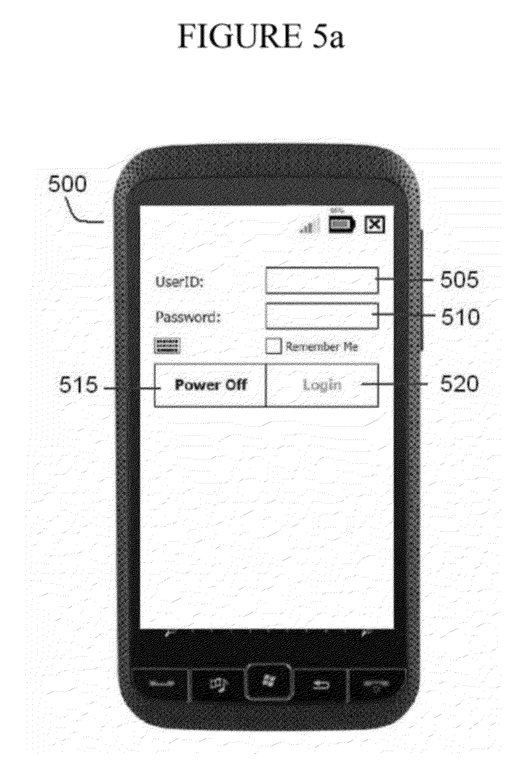

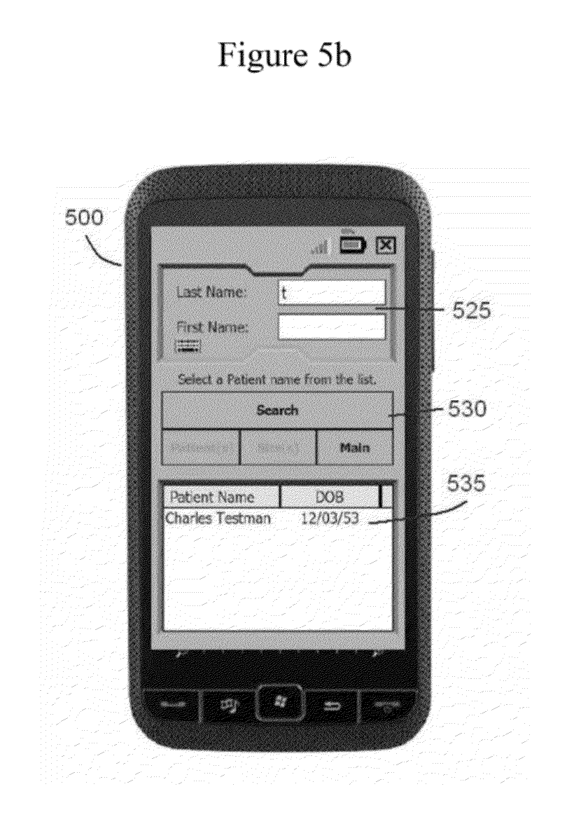

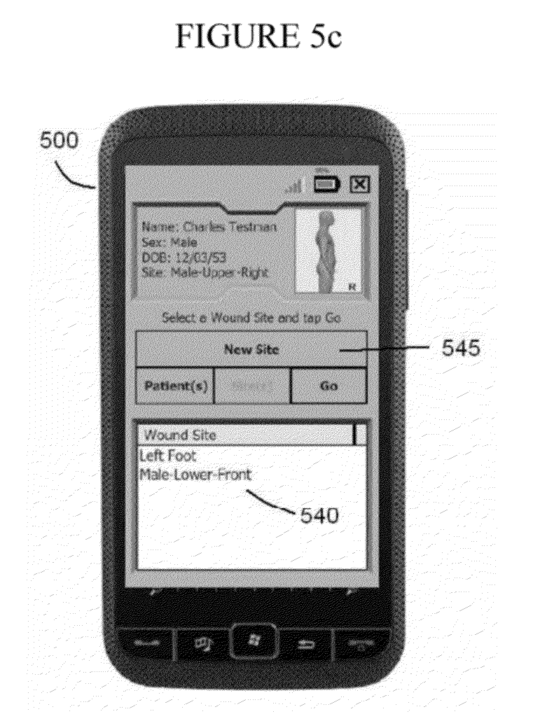

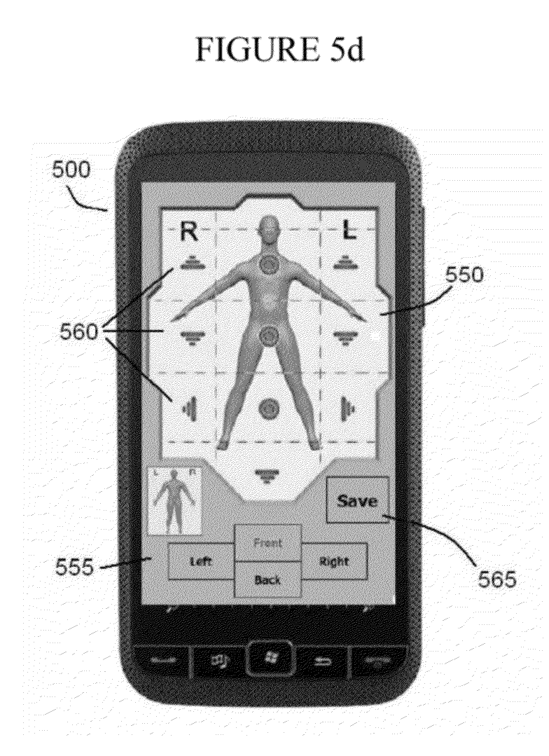

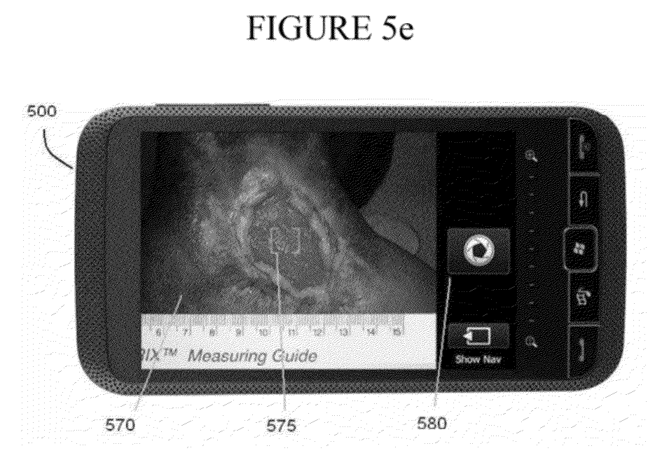

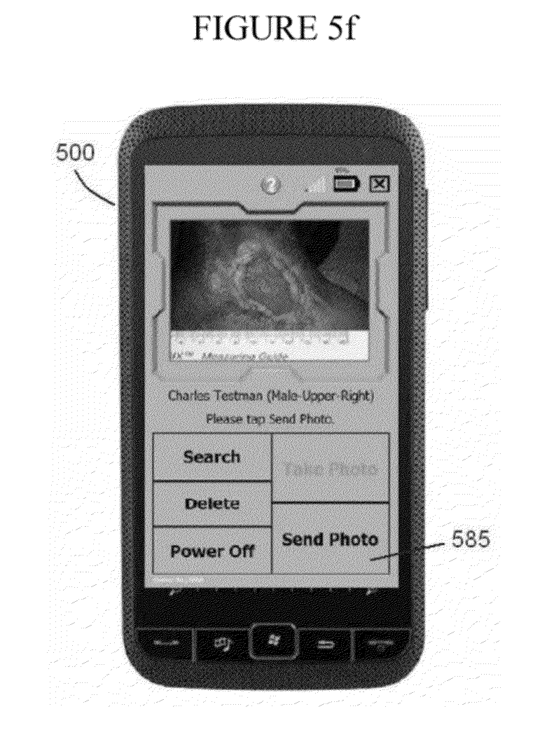

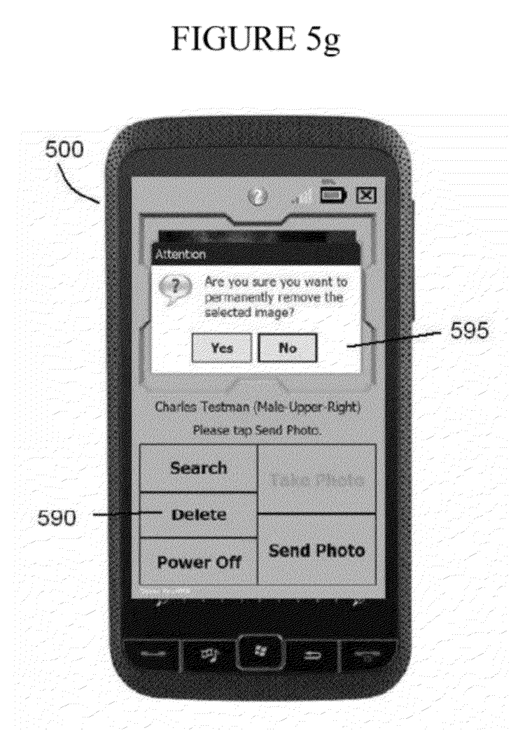

Similarly, an in-home caregiver may have a single mobile device including a similar application for use with multiple patients for whom the caregiver is providing treatment. The caregiver's mobile device may allow the caregiver to access a patient's record and capture and upload additional images associated with that specific patient's record. An exemplary process and application interface for a caregiver's mobile device is discussed below with respect to FIGS. 4 and 5a-5g.

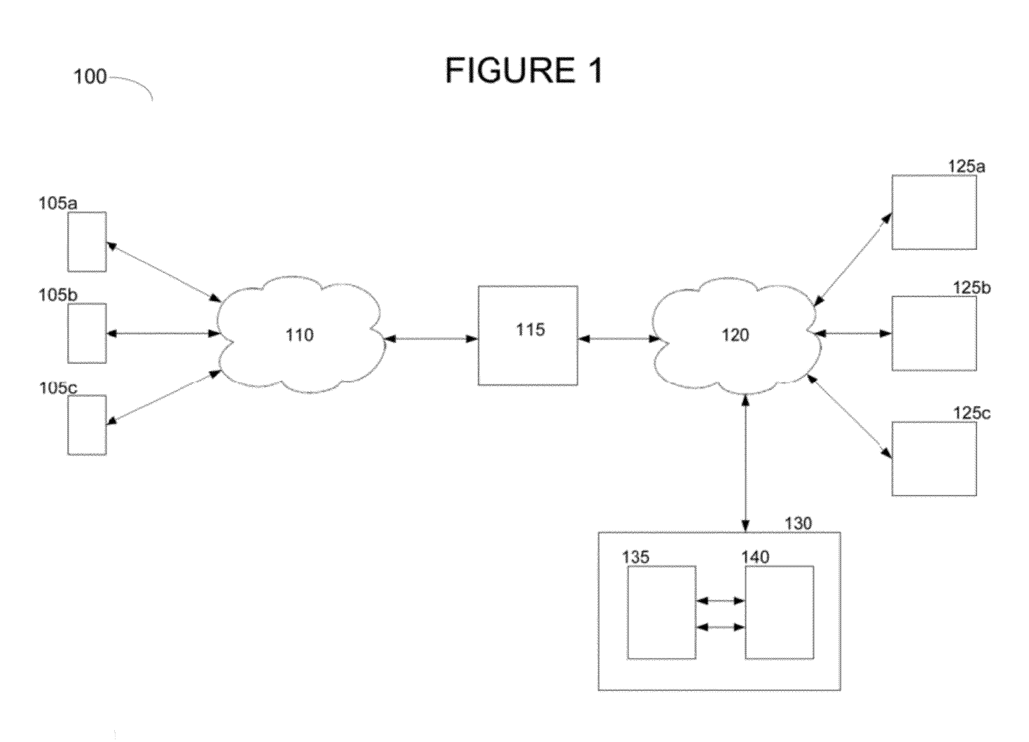

FIG. 1 illustrates an exemplary data network 100. The network 100 may include a plurality of mobile devices 105a, 105b and 105c. The mobile devices 105a, 105b and 105c may be operably connected to a network 110 via a wireless connection. The network 110 may be a local area network, such as an intranet, or a wide area network, such as the Internet. The mobile devices 105a, 105b and 105c may be operably connected to the network 110 via a standard wireless connection, such as Wi-Fi (e.g., via IEEE standard 802.11n). Alternatively, the mobile devices 105a, 105b and 105c may be connected to the network 110 via a cellular wireless data standard, such as a 3G data connection.

The network 110 may be operably connected to a second network 120 via a firewall 115. The second network may be a secure local area network, such as a hospital intranet, and thus require the security provided by the firewall. Multiple workstations 125a, 125b and 125c may be operably connected to the network 120. Additionally, a back-end 130 may be operably connected to the network 120. The back-end 130 may include one or more database servers 135 operably connected to one or more application servers 140. The back-end 130 may be configured to interact with the mobile devices 105a, 105b and 105c to allow for patient identification and image capture/uploading via the mobile devices. The back-end 130 may be further configured to interact with the workstations 125a, 125b and 125c to allow for a user of the workstations to access patient related information stored on the database server 135. The function of the various devices as shown in FIG. 1, including the interaction between the mobile devices 105a, 105b and 105c and the back-end 130, is discussed in greater detail with respect to FIGS. 2-6.

It should be noted the arrangement and number of components as shown in FIG. 1 is shown by way of example only. Additional configurations of components may be used depending on the configuration and intended application of the network 100.

FIGS. 2 and 3a-3g will be alternatively discussed to illustrate a first exemplary embodiment of the present disclosure. FIG. 2 illustrates an exemplary process that may be performed such that a patient can capture, define, review and upload one or more medical images from a mobile device (e.g., one of mobile devices 105a, 105b and 105c as shown in FIG. 1) to a secure server (e.g., application server 140 as shown in FIG. 1) for review and evaluation by a medical professional via a secure workstation (e.g., one or workstations 125a, 125b and 125c as shown in FIG. 1) operably connected to the server.

When a mobile device is issued or otherwise configured for a patient's use, the patient and associated information may be enrolled 202. Enrollment 202 may include creating a digital patient record including vital information related to the patient. Enrollment 202 may further include associating a mobile device identification (ID) number with the patient's record. The patient may then access a dedicated application installed on the mobile device to acquire and upload digital images to the secure server. Specifically, the patient may use the dedicated application to acquire and upload wound images for recording a wound care management process the patient is following.

When the mobile device is initialized, the software may display 204 a welcome screen where the patient can view 204 various function buttons to select a function to perform. FIG. 3a shows an exemplary screenshot of the welcome screen as viewed 102 upon initialization of the mobile device 300. As shown in FIG. 3A, no medical images have yet been captured and thus, there are no thumbnails to view. Rather, the screen 305 provides a welcome and an instruction to take a photo.

The initial screen may include options for the patient to select 206 power off, select 208 location, select 210 take photo, select 212 send photo, and select 214 delete. As shown in FIG. 3a, upon initialization, the button 310 for selecting 204 power off may be selectable along with the button 315 for selecting 210 take photo. The other buttons may be grayed out and inaccessible.

The patient may select 210 take photo by pressing button 315. Selecting 210 take photo may cause the software application to enter photo acquisition mode as shown in FIG. 3b. In this mode, the layout of the software application may shift to landscape mode, thus prompting the patient to rotate the mobile device 300 such that the mobile device is situated like a traditional camera. The software may display a screen 320 showing what is being captured by the camera component of the mobile device 300. A focus icon 325 may be included for centering the image on the area of concern. The patient may acquire 216 the image by pressing the acquire image button 330 on the mobile device 300. When the patient pushes the acquire image button 330, the camera component of the mobile device 300 may perform various functions depending on its capabilities. For example, the camera component may auto-focus, stabilize the image, detect surrounding light levels and, if the light levels are too low, produce a flash.

In accordance with a doctor's instructions, the patient may include a measuring device in the image to provide a reference as to the scale of the image being acquired 216. For example, as shown in FIG. 3b, a ruler is included in the image. The measuring device may provide a medical professional analyzing the captured image a reference object to gauge the size of the wound or area of concern being photographed. The medical professional may then be able to calibrate the captured medical image on their display device based upon the measuring device such that they are looking at a life-sized view of the medical image. It should be noted that the measuring device is shown in FIG. 3B as a ruler for exemplary purposes only. Additional measuring devices with a known set of dimensions, such as a coin, may additionally or alternatively be used. Similarly, a color swatch may be used to provide a color calibration feature.

After the patient acquires 216 the medical image, the software may prompt, via textual and visual prompting, the patient to determine 218 a location of where on the patient's body the image was acquired 216 from. The mobile device may display 220 a location selection screen. An exemplary location selection screen is shown in FIG. 3c. From the location selection screen, the patient may select 222 a location indicating where the image was acquired 216 from. A screen 335 may be displayed on the mobile device 300 including an avatar of a human body. Multiple views of the avatar may be cycled through by selecting one of the directional buttons 340. For example, the patient may view the avatar from the front, right, back or left. Each individual view may be divided into multiple regions of interest 345. The patient may select 222 one of the specific regions of interest 345, thereby indicating where on their body the image was acquired 216 from. The patient may exit the location screen by selecting a save button 350.

After selecting 222 a location, the software application may return to the welcome screen 204. FIG. 3d illustrates an exemplary view of the screen 305 including the acquired 216 image. Here, additional buttons are available to select, including button 355 for selecting 212 to send the photo, button 360 for selecting 214 to delete the image, and button 365 to select 208 the location. If the patient selects button 365 for selecting 208 the location of the image, the process is identical to the above-discussed process for displaying 220 the location select screen and selecting 222 a location. A patient may select 208 the location again if they previous entered the location of the image incorrectly.

The patient may select 212 to send the acquired 216 photo. If not already connected, the mobile device 300 may establish a wireless network connection with the application server and initiate the uploading process. As shown in FIG. 3e, the screen 305 may indicate the upload is in progress. The upload process may include uploading 224 a device identifier. As discussed above, during enrollment 202, a patient's record may be associated with a specific device identifier, thereby linking the patient's record with the mobile device 300 assigned to the patient. During the upload process, the mobile device 300 uploads 224 the device identifier. The application server receives the identifier and, based upon this information, identifies the patient's record associated with the image to be uploaded. The image is then uploaded 226 to the application server. Additionally, information specific to the image being uploaded 226 may be uploaded as well. For example, information related to the location of the wound included in the image, date and timestamp information, and other related information to the acquisition 216 of the image may be uploaded to the application server as well.

Depending on the configuration of the mobile device 300 and the application server, one or more encryption techniques may be used to ensure the image is securely transmitted. Additionally, HIPAA regulations may require a particular encryption/decryption technique be used. Once the image is uploaded 226, the image may be removed 228 from the mobile device 300 for additional patient security. FIG. 3f illustrates an exemplary view showing screen 305 of the mobile device 300 confirming the image was uploaded 226 successfully.

The patient may also select 214 to delete an acquired 216 image. The patient may be prompted 230 to confirm that he wishes to delete an image. If the software application determines 232 the patient has selected to delete the image, the image is deleted 234 from the mobile device 300 and the software returns to the welcome screen 202. If the software determines 232 the patient does not wish to delete an image, the software returns to the welcome screen 202 where the patient may select another option for processing the acquired 216 image. FIG. 3g illustrates an exemplary view of mobile device 300 where a prompt 370 is displayed on screen 305, requesting the patient confirm deletion of the image.

The patient may also select 206 to power off the mobile device 300. Upon selecting 206 to power off, any images captured by the device may be deleted 238 and the application ends.

It should be noted the process as discussed above is shown by way of example only and may be modified. For example, a feature may be incorporated where after a set amount of time after an image is acquired 216 (e.g., 2 minutes), the image may be automatically uploaded 226 to the secured server. Similarly, the patient may only be prompted to determine 218 a location of the image the first time the patient uses the mobile device. The mobile device may then default to that location for each additional image acquired 216.

After the image is uploaded 226, a user at one of the workstations may access the back-end (e.g., back-end 130) to view and analyze the wound images. Analysis may include determining the size of the wound, measuring growth or deterioration of healthy tissue, tracing an outline of the wound and performing plametric measuring of the surface area of the wound, and other similar analysis techniques.

Additional safety features may be implemented into the software application to protect the personal information of the patient. For example, if the mobile device enters a sleep mode, or otherwise is inactive for a period of time (e.g., 10 minutes), an acquired image stored on the device may be deleted. Additionally, a user name/password security feature may be implemented into the software, thereby requiring a patient log on to access the software application.

FIGS. 4 and 5a-5g will be alternatively discussed to illustrate a second exemplary embodiment of the present disclosure. FIG. 4 illustrates an exemplary process that may be performed such that a caregiver can capture, define, review and upload one or more medical images of a patient under the supervision of the caregiver from a mobile device (e.g., one of mobile devices 105a, 105b and 105c as shown in FIG. 1) to a secure application server (e.g., application server 140 as shown in FIG. 1) for review and evaluation by a medical professional via a secure workstation (e.g., one or workstations 125a, 125b and 125c as shown in FIG. 1) operably connected to the application server.

The caregiver may have an associated mobile device used by the caregiver to capture and upload wound images for multiple patients under the supervision of the caregiver. When a mobile device is issued or otherwise configured for a caregiver's use, the caregiver is assigned a username and password for logging 402 into the device. FIG. 5a illustrates an exemplary log in screen as displayed on mobile device 500. The log in screen may include a username or ID field 505, a password field 510, a Power Off button 515 and a Login button 520. The caregiver may enter their username and password into the appropriate fields 505 and 510 and select login 520 to unlock the mobile device 500 and access the application server.

Once the caregiver has accessed 402 the device, the software application may determine 404 if the caregiver is visiting a new patient or an existing patient. If the caregiver is visiting an existing patient, the caregiver may search 406 for the existing patient's record. FIG. 5b illustrates an exemplary search screen. The caregiver may enter the patient's name into fields 525 and select a search button 530. Results 535 of the search may be displayed for selection by the caregiver.

If the patient is determined 404 to be a new patient, the caregiver may enroll 408 the new patient via the mobile device. As before, enrollment 408 may include creating a digital patient record including vital information related to the patient.

If the patient is an existing patient, the caregiver may decide 410 if the patient's wound is at a new site or an existing site already listed in the patient's record. If the site is an existing site, the caregiver can select 414 the existing site from the patient's record. As shown in FIG. 5c, a list 540 of existing sites for a patient is shown on mobile device 500. The caregiver may also select button 545 to locate 412 a new site. Additionally, if the patient is enrolled 408 as a new patient, the caregiver may select 412 a new site as well.

FIG. 5d illustrates an exemplary screen that mobile device 500 may display if the caregiver opts to select 412 a new site. The software application may prompt, via textual and visual prompting, the caregiver to determine a location of where on the patient's body a wound being photographed is located. The mobile device 500 may display a location selection screen 550. The location selection screen 550 may include an avatar of a human body. Multiple views of the avatar may be cycled through by selecting one of the directional buttons 550. For example, the caregiver may view the avatar from the front, right, back or left. Each individual view may be divided into multiple regions of interest 560. The caregiver may select the appropriate region and exit the location screen by selecting the save button 565.

Once the caregiver has identified a site, the caregiver may take 416 a photo of the wound. FIG. 5e illustrates an exemplary view of the mobile device 500 in ready to take a photo. In this mode, the layout of the software application may shift to landscape mode, thus prompting the caregiver to rotate the mobile device 500 such that the mobile device is situated like a traditional camera. The software may display a screen 570 showing what is being captured by the camera component of the mobile device 500. A focus icon 575 may be included for centering the image on the area of concern. The caregiver may take 416 the photo by pressing the acquire image button 580 on the mobile device 500. When the caregiver pushes the acquire image button 580, the camera component of the mobile device 500 may perform various functions depending on its capabilities. For example, the camera component may auto-focus, stabilize the image, detect surrounding light levels and, if the light levels are too low, produce a flash.

After taking 416 an image, the caregiver may opt to send 418 the photo to the application server or delete 422 the photo from the phone. FIG. 5f shows an exemplary screenshot of an acquired image and a send photo 585 button for sending 418 the photo securely from the mobile device to the application server. Conversely, FIG. 5g shows a screenshot of the mobile device 500 when a caregiver selects to delete a photo. Upon selecting the delete button 590, the software application may display a prompt 595 confirming the caregiver wishes to delete the photo. The caregiver may select to delete the photo or to return to the acquired image screen (as shown in FIG. 5f). After the caregiver sends 418 a photo to the application server, the caregiver may opt 420 to take 416 another photo.

As discussed above, after a photo is sent 418, a user at one of the workstations may access the back-end (e.g., back-end 130) to view and analyze the wound images. Analysis may include determining the size of the wound, measuring growth or deterioration of healthy tissue, tracing an outline of the wound and performing plametric measuring of the surface area of the wound, and other similar analysis techniques.

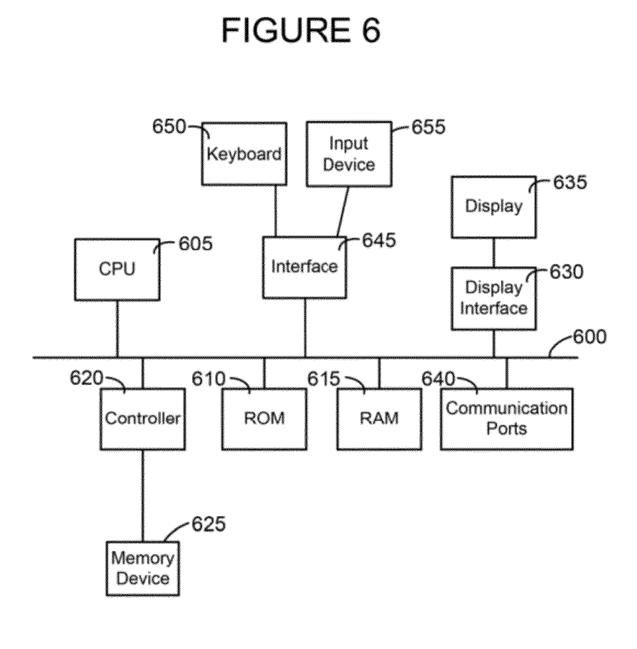

FIG. 6 depicts a block diagram of exemplary internal hardware that may be incorporated into the mobile devices as discussed above. A bus 600 serves as the main information highway interconnecting the other illustrated components of the hardware. CPU 605 is the central processing unit of the system, performing calculations and logic operations required to execute a program. CPU 605, alone or in conjunction with one or more of the other elements disclosed in FIG. 6, is an exemplary processing device, computing device or processor as such terms are used within this disclosure. Read only memory (ROM) 610 and random access memory (RAM) 615 constitute exemplary memory devices.

A controller 620 interfaces with one or more optional memory devices 625 to the system bus 600. These memory devices 625 may include, for example, a hard drive, flash memory, or the like. Additionally, the memory devices 625 may be configured to include individual files for storing any acquired images, software modules or instructions, auxiliary data, common files for storing groups of results and related information as discussed above.

Program instructions, software or interactive modules for performing any of the functional steps associated with the software applications as discussed above may be stored in the ROM 610 and/or the RAM 615. Optionally, the program instructions may be stored on a tangible computer readable medium such as a flash memory, a memory card and/or other recording medium.

A display interface 630 may permit information from the bus 600 to be displayed on the display 635 in audio, visual, graphic or alphanumeric format. The information may include an acquired image and other related information. Communication with external devices may occur using various communication ports 640. An exemplary communication port 640 may be attached to a communications network, such as the Internet or a local area network.

An input interface 645 may be operably connected to an input device 655 such as the camera component as discussed above as well as a keyboard 650. In the mobile device as discussed above, the display 635 may also be configured to act an in input device 655 via a touch-screen interface.

It will be appreciated that various of the above-disclosed and other features and functions, or alternatives thereof, may be desirably combined into many other different systems or applications. It will also be appreciated that various presently unforeseen or unanticipated alternatives, modifications, variations or improvements therein may be subsequently made by those skilled in the art which are also intended to be encompassed by the disclosed embodiments.

What is claimed is:

1. A method of acquiring and transmitting an image from a mobile device to a server, the method comprising:
acquiring, via a camera component of the mobile device, an image of a wound on a patient's body;
receiving, by a processing device operably connected to the camera component, location information associated with the acquired image, wherein the location information indicates where on the patient's body the wound is located; and
transmitting, in response to a user request, the acquired image and location information to the server via a communications interface operably connected to the processing device.

2. The method of claim 1, further comprising associating identification information unique to the mobile device with the acquired image.

3. The method of claim 2, further comprising transmitting the identification information along with the acquired image.

4. The method of claim 1, wherein the receiving the location information further comprises:
displaying, via a display operably connected to the processing device, an image of a human body having a plurality of selectable regions of interest;
receiving a user selection of at least one of the plurality of selectable regions of interest; and
defining the location information based on the user selection.

5. The method of claim 1, further comprising enrolling a patient by associating a unique identifier associated with the mobile device to a patient's record such that any information received at the server from the mobile device is associated with the patient's record.

6. The method of claim 1, further comprising deleting an acquired image from the mobile device.

7. The method of claim 6, wherein the deleting the acquired image occurs if the acquired image is not transmitted to the server within a time period.

8. The method of claim 6, wherein the deleting the acquired image occurs in response to receiving a user request to delete the image.

9. The method of claim 6, wherein the deleting the acquired image occurs after the acquired image is transmitted to the server.

10. The method of claim 1, further comprising establishing a connection between the mobile device and the server via a cellular telephone network.

11. A mobile device for capturing and transmitting medical images, the device comprising:
a camera component configured to acquire an image;
a communications interface configured to establish an operable connection to a server; and
a processing device operably connected to the camera component and the communications interface, and configured to:
cause the camera component to acquire an image of a wound on a patient's body,
receive location information associated with the acquired image, wherein the location information indicates where on the patient's body the wound is located, and
transmit, in response to a user request, the acquired image and location information to the server via the communications interface.

12. The mobile device of claim 11, wherein the mobile device further comprises a non-transitory storage medium comprising unique identification information.

13. The mobile device of claim 12, wherein the processing device is further configured to transmit the unique identification information with the acquired image.

14. The mobile device of claim 11, wherein the mobile device further comprises a display operably connected to the processing device, and wherein the processing device is further configured to:
cause the display to display an image of a human body having a plurality of selectable regions of interest;
receive a user selection of at least one of the plurality of selectable regions of interest; and
define the location information based on the user selection.

15. The mobile device of claim 11, wherein the mobile device further comprises a non-transitory storage medium, and wherein the processing device is further configured to store the acquired image on the non-transitory storage medium.

16. The mobile device of claim 15, wherein the processing device is further configured to delete the acquired image from the mobile device.

17. The mobile device of claim 15, wherein the processing device is further configured to delete the acquired image if the acquired image is not transmitted to the server within a time period.

18. The mobile device of claim 15, wherein the processing device is further configured to delete the acquired image in response to receiving a user request to delete the image.

19. The mobile device of claim 15, wherein the processing device is further configured to delete the acquired image after the acquired image is transmitted to the server.

20. The mobile device of claim 11, wherein the operable connection between the communications interface and the server comprises a cellular telephone network.
